(19) United States
(12) Patent Application Publication
(10) Pub. No.: US 2014/0297649 A1
(43) Pub. Date: Oct. 2, 2014

(54) Method and System for Providing and Managing Information of Prefabricated Construction Components between Manufacturers and Architects

(71) Applicants: Rahinah Ibrahim, Selangor Darul Ehsan (MY); Rusli Abdullah, Selangor Darul Ehsan (MY); Mohd Saleh Jaafar, Selangor Darul Ehsan (MY); Mazlyar Mamdooh, Selangor Darul Ehsan (MY)

(72) Inventors: Rahinah Ibrahim, Selangor Darul Ehsan (MY); Rusli Abdullah, Selangor Darul Ehsan (MY); Mohd Saleh Jaafar, Selangor Darul Ehsan (MY); Mazlyar Mamdooh, Selangor Darul Ehsan (MY)

(21) Appl. No.: 14/355,907

(22) PCT Filed: Aug. 16, 2012
(86) PCT No.: PCT/MY2012/000233

§ 371 Date: May 21, 2014

(30) Foreign Application Priority Data
Nov. 2, 2011 (MY) PI2011005283

(51) Int. Cl. G06F 17/30

(52) U.S. Cl. CPC G06F 17/30601
USPC 707/740

(57) ABSTRACT

The present invention discloses a method (100) for providing and managing information of prefabricated construction components between manufacturers and architects to be used into architectural modular design processes. The manufacturer's product information relating to various prefabricated construction components are aggregated (101). A unique code is assigned to each prefabricated construction component (103) by synthesising product information of the prefabricated construction component into coding syntaxes and stored into a database (105). the product information in the format of the unique codes are then distributed on demand of architects for their architectural modular designs processes (107).

### FIELD OF INVENTION

The present invention relates to a method and system for providing and managing information of prefabricated construction components between manufacturers and architects for modular architectural design processes. More particularly, the invention relates to a method and a system for aggregating, assigning unique codes, and distributing product information in the format of unique codes on demand of architects for their modular architectural design processes.

### BACKGROUND OF THE INVENTION

For naming objects in construction, there are three well-known standards of layer naming in the global CAD environment which are:

1) European Classification Layering System ISO 13567, an International standard;

2) British Standard in Layering System BS 1192, which relies heavily on the Code of Procedure for the Construction Industry, AEC[UK], an adaptation of IBS 1192 based on Uniclass System; and

3) AIA CAD Layer Guidelines by American Institute of Architects in NCS which has a wide usage in the USA.

However, the above naming systems are not suitable for naming 3D objects in CAD system. The naming systems are not suitable for naming prefabricated building components and for visualisation in construction management such as 4D, 5D onwards. Furthermore, the naming systems are not convenience due to architects' requirements in the 3D modelling process. Also, the aforementioned naming systems require a supplementary code book as a reference for further practicing.

There are various systems that are working as Building Component Library in construction industry having:

i. Autodesk Seek® (Autodesk, 2010)

ii. RIBA Product Selector® (ABC-UK, 2010)

iii. E-union® (Kong et al., 2005)

iv PLA (id)® (Ofluoglu et al., 2002)

v. Active Cat® (Ling, Kim, Will & Luo, 1997)

vi. ARROW® (Amor & Newnham, 1999)

vii. R1NET® (Hannus & Pirhonen, 2001)

viii. PROMIS® (Owolabi et al. 2003)

ix. SmartBIM® (Reed Construction Data, 2008)

x. ARCAT® (ARCAT, 2008)

However, the above systems do not have convenient searching engines for prefabricated building design requirements. The systems are also not convenient at providing vast range of product information for architectural practice. Furthermore, the system requires technicians for inputting information. Also, the systems are not easy for further access in order to update, edit or omit the uploaded information. The systems do not have real-time communication facility between the suppliers (manufacturers) and demanders (architects). Moreover, the systems are not convenient for 3D Modelling practice using technical product naming. Furthermore, the systems are not easy to maintain, therefore they impose fee to accessing and using.

Therefore, there is a need for a method and system for providing and managing information of prefabricated construction components between manufacturers and architects for their modular architectural design processes to overcome the above disadvantages.

### SUMMARY OF INVENTION

It is therefore an object of the invention is to provide a method for providing and managing information of prefabricated construction components between manufacturers and architects for architectural modular design processes comprising the steps of aggregating the manufacturers' product information relating to various prefabricated construction components; assigning a unique code to each prefabricated construction component by synthesising product information of the prefabricated construction components using coding syntaxes (111); storing the product information in a database in the format of the unique codes; and distributing the product information in the format of the unique codes on demand of architects for their architectural modular design processes.

Another object of the present invention is to provide the step of distributing the product information of the prefabricated construction components which can be achieved by the architects using a searching system to search the database of the relevant production information for their modular design processes requirements.

Another object of the present invention is to provide the step of identifying the most viewed and commented products and highlighting them as the most popular and favourable components in comparison to the others.

Another object of the present invention is to provide the step of recording the architects' desired construction components for reference of the manufacturers.

Still another object of the present invention is to provide the step of recording the architects' recommendation about the stored components after the architects obtained the product information for each construction component from the database.

Yet another objective of the present invention is to provide a system for providing and managing information of prefabricated construction components through a server and an interface between manufacturer and architect for architectural modular design processes, the comprises an information aggregation module adapted to aggregate the manufacturers' product information relating to various prefabricated construction components; a coding module adapted to assign a unique code to each prefabricated construction component by synthesising the prefabricated construction components information using coding syntaxes; a database adapted to store the product information in the format of the unique codes; and an information distribution module adapted to distribute the product information in the format of the unique codes on demand of architects for their architectural modular design processes.

The present preferred embodiments of the invention consists of novel features and a combination of parts hereinafter fully described and illustrated in the accompanying drawings and particularly pointed out in the appended claims; it being understood that various changes in the details may be effected by those skilled in the arts but without departing from the scope of the invention or sacrificing any of the advantages of the present invention.

### BRIEF DESCRIPTION OF THE DRAWINGS

These and other features, aspects and advantages of the present invention will be more fully understood when considered with respect to the following detailed descriptions, appended claims and accompanying drawings wherein:

FIG. 1 is a flow chart illustrating a method for providing and managing information of prefabricated construction components between manufacturers and architects for architectural modular design process, in accordance with an aspect of the present invention;

FIG. 2 is a flow chart illustrating the method of FIG. 1 further comprising the steps of identifying the most view products, recording the architect's desired construction components and recording the architects' recommendation in accordance with an aspect of the present invention;

FIG. 3 is a block diagram depicting a system for providing and managing information of prefabricated construction components through a server and an interface between manufacturer and architect for architectural modular design process, in accordance with an aspect of the present invention;

FIG. 4 is a block diagram depicting the system of FIG. 3 further comprises a favor identification module, reference module and recommendation module, in accordance with an aspect of the present invention;

FIG. 5 is a computer screenshot that shows the generation of coding syntax of a prefabricated construction component;

FIG. 6 is a table that shows the coding syntaxes of the prefabricated construction components of a 3D model are assigned;

FIG. 7 is a computer screenshot that shows the aggregated product information is automatically assigned logical linking to the relevant information fields to generate the unique codes for the prefabricated construction components;

FIG. 8 is a computer screenshot that shows a searching system for distribution of the product information of the prefabricated construction components;

FIG. 9 is a computer screenshot that shows a favor identification module for identifying the most viewed and commented products and highlighting them as the most popular and favourable components in comparison to the others;

FIG. 10 is a computer screenshot that shows a reference module for recording the architects' desired construction components for reference of the manufacturers.

### DETAILED DESCRIPTION OF THE INVENTION

Hereinafter, the invention shall be described according to the preferred embodiments of the present invention and by referring to the accompanying description and drawings. However, it is to be understood that limiting the description to the preferred embodiments of the invention and to the drawings is merely to facilitate discussion of the present invention and it is envisioned that those skilled in the art may devise various modifications without departing from the scope of the appended claim.

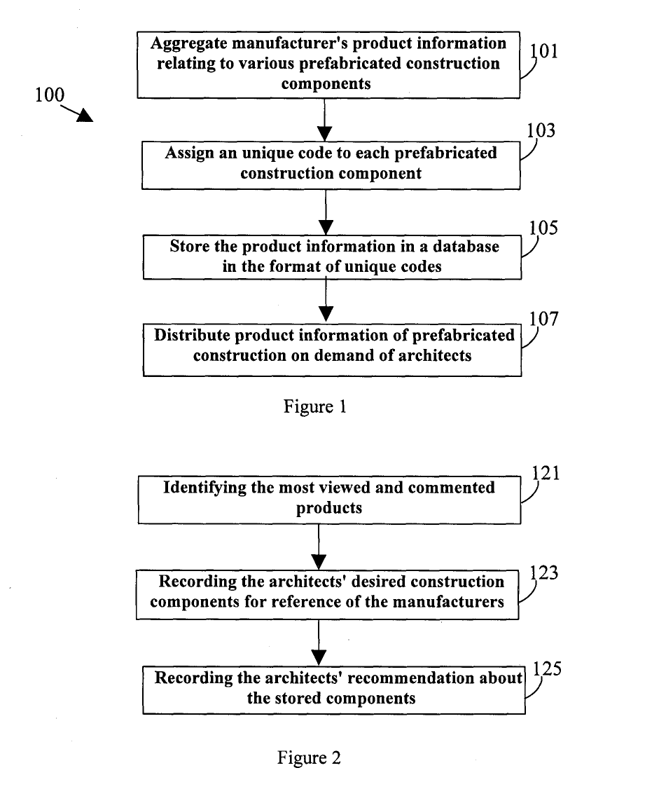

The present invention discloses a method and system for providing and managing information of prefabricated construction components between manufacturers and architects for architectural modular design process. FIG. 1 illustrates the method of the invention in the form of a flow chart. As illustrated, methodology starts at step 101, wherein product information of the prefabricated construction components are aggregated from manufacturers of the prefabricated construction components. At step 103, a unique code is assigned to each prefabricated construction component. Further at step 105, the product information are then stored in a database in the format of the unique codes. Finally at step 107, the product information of the prefabricated construction components are distributed in the format of unique codes on demand of architects for their architectural modular design processes.

Referring now to FIG. 2, there is shown the method of FIG. 1 further comprising the steps of identifying the most view products, recording the architect's desired construction components and recording the architects' recommendation. At step 121, the most viewed and commented products may be identified and highlighted as the most popular and favourable components in comparison to the others. At step 123, the architects' desired construction components may be recorded for reference of the manufacturers. At step 125, the architects' recommendation about the stored components may be recorded after the architects obtained the product information for each construction component from the database.

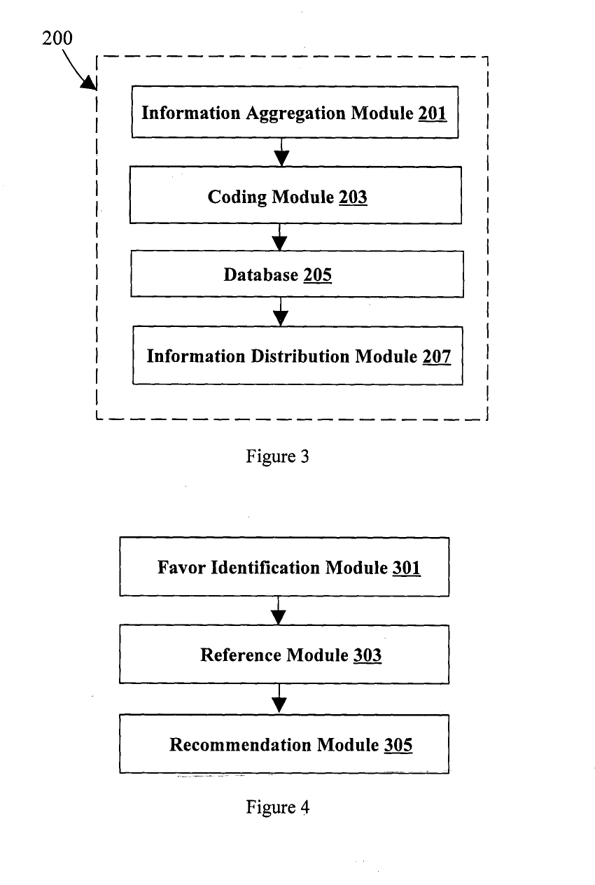

Referring now to FIG. 3, there is shown a system (200) for providing and managing information of prefabricated construction components through a server and an interface between manufacturer and architect for architectural modular design processes. An information aggregation module (201) is adapted to aggregate the product information of the prefabricated construction components from manufacturers of the prefabricated construction components. A coding module (203) is adapted to assign a unique name to each prefabricated construction component by synthesising the prefabricated construction components information using coding syntaxes. A database (205) is adapted to store the aggregated product information in the format of codes. An information distribution module (207) is adapted to distribute the product information of the prefabricated construction components in the format of unique codes on demand of architects for their architectural modular designs processes. The manufacturers access the server through their own interface for uploading their product information and the architects search based on a dedicated searching system for finding prefabricated construction component throughout the server. Preferably, the server is located in the internet for secured access of user. Each user needs to register and verify their own identity before having permission to the server within two categories of manufacturer or architect. Product information will be transferred through both manufacturer and architect online while manufacturer uses backend and architect uses front-page system. The information will be received directly from manufacturers with no interference using technical entry-form including uploading file, which is represented product information of construction components. The product information of the prefabricated construction components to be aggregated from their manufacturers are parametrical information of the prefabricated construction components. Referring now to FIG. 4, there is shown the system further comprises a favor identification module, reference module and recommendation module. The favor identification module (301) is adapted for identify the most viewed and commented product and highlighting them as the most popular and favourable components in comparison to the others. The reference module (303) is adapted for recording the architects' desired construction components for reference of the manufacturers. The recommendation module (305) is adapted for recording the architects' recommendation about the stored component after the architects obtained the product information for each construction component from the database (205).

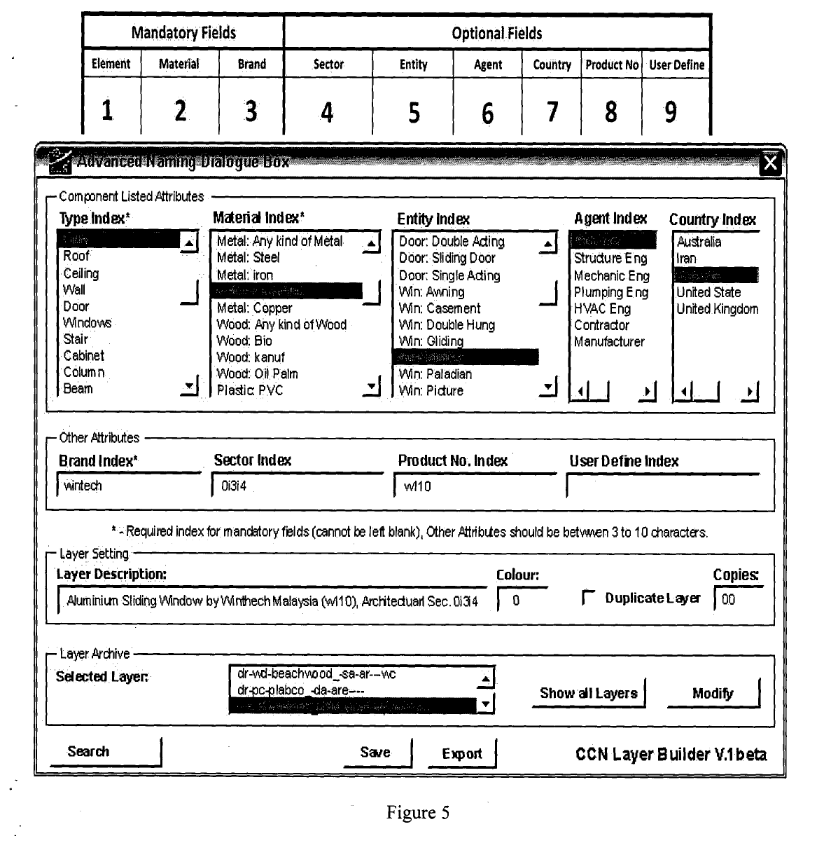

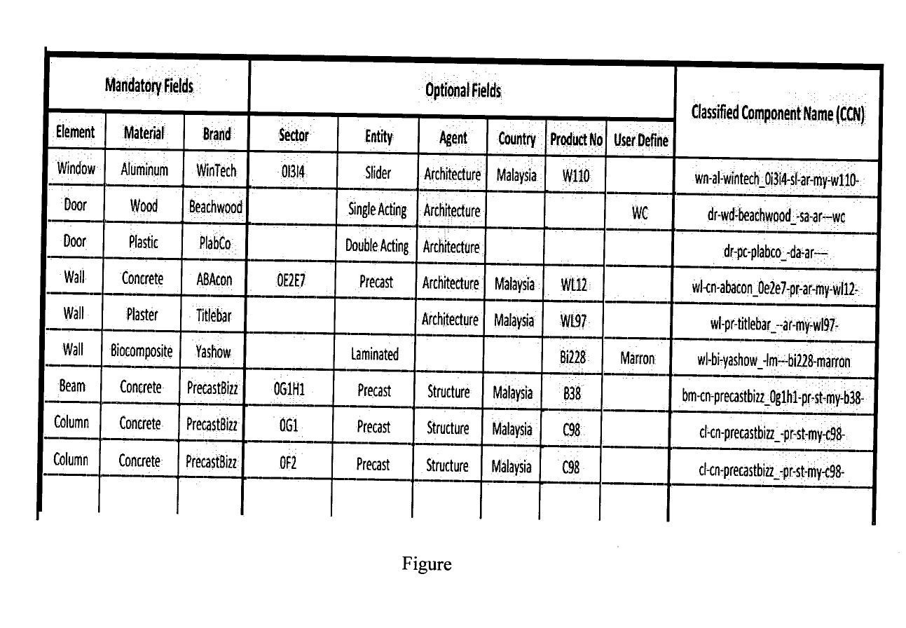

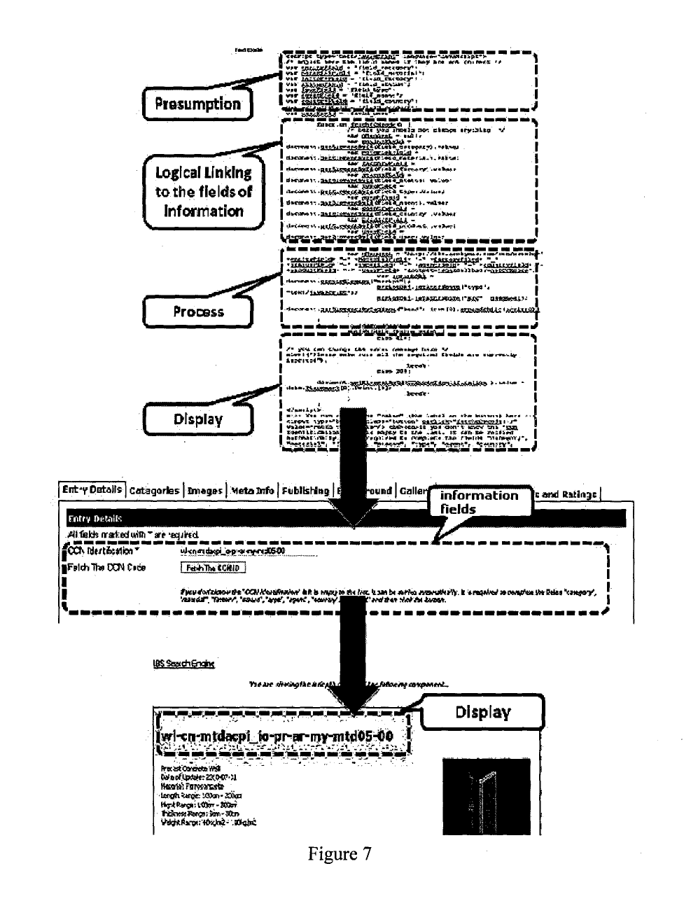

Referring now to FIG. 5, there is shown a computer screenshot of an interface of the system that carries out the generation of coding syntax of a prefabricated construction component. The unique code for each construction component comprises abbreviation relating to attributes of each of the prefabricated construction components. The coding syntaxes for the construction components comprise a plurality of information fields. The information fields are arranged systematically into two sections which are mandatory and optional fields. The first section is ‘Mandatory’. Mandatory fields are essential to be filled by the original producer of the building component. The mandatory information fields are information relating to element, material and brand of the prefabricated construction components. The second section is ‘Optional’. The optional information fields are information relating to the sector, entity, agent, country, product number and user define of the prefabricated construction components. These types of information are optional to be filled and it is better to assign those who have the responsibility for manipulating them in a 3D model. It may be filled by the user or or producer. Therefore, the combinations of all Mandatory fields and Optional fields will shape the final coding syntaxes. Eventually the coding module reflects in the product qualifications based on prefabricated design requirements and manufacture productivity. Preferably, the coding syntaxes are assigned and generated automatically by the coding module after the product information of the prefabricated construction components are aggregated. The coding module has a computer program to firstly make presumption of aggregated product information which relevant to the information fields. The aggregated product information will be then automatically assigned a logical linking to the relevant information fields and processed to generate the unique codes for the prefabricated construction components as shown in FIG. 7.

It is rational that each CAD practitioner develops their own coding syntax as a legacy of the coding module instead of using full long term for any common construction project. Obviously, this will also have its own benefits for them like:

1) there is too much information in one single phrase;

2) in CAD tools, usually there is no description column for future cross referencing;

3) the codes give them essential information in a short glance and occupy less space.

The coding module structure can enhance the ISO 13567 structure principles in order to support 3D modelling requirement using prefabricated construction components. It has two types of field (Mandatory and Optional) like ISO 13567, but in a different format. The eventual syntax has nine fields (three mandatory fields+six optional fields) that should be properly filled to define a 3D prefabricated component in a 3D model. The fields are segregated by ‘-’ and the categories (mandatory and optional) are divided by ‘-’. Also, the user must use ‘--’ to show the field is left unfilled, if it is supposed to be unfilled. In the following, the coding syntaxes are explained as below:

Field 1: Element (2 Characters)—Mandatory

The field is adopted to show the type of component like “FL’ for Floors, “WN” for Windows, and “WL” for Walls, etc. If an element code is longer than two characters, it should be highlighted in the legend description. User may follow this field in accordance to International Standard STEP or their country standardisations.

Field 2: Material (2 Characters)—Mandatory

The field is adopted to signify the material type of component. Materials like Steel, Aluminium, Wood or Concrete, etc. This filed is coded with two characters represent of material type. For instance, “AL” for aluminium type or “WD” for wood type.

Field 3: Brand (3-10 Characters)—Mandatory

The field is adopted to state the brand factory of the component. The factory names are various and sometime very similar to each other, therefore, it is better to do not restrict the characters for better distinguishing the original producer. However, it is suggested this field to be capped for maximum ten characters, For instance, “WinTech” is a name for a brand in producing building window types. So that, the name should state exactly in the field for the brand.

Field 4: Sector (2-5 Characters)—Optional

The field is adopted to indicate the location of elements or the preferred location for the component, such as: outdoor.

Field 5: Entity (Unlimited Characters)—Optional

The field is adopted to signify who is responsible for the creation of the components like Architectural Component (“AR”) or Structural one (“ST”).

Field 6: Agent (2 Characters)—Optional

The field is adopted to signify who is responsible for the creation of the components like Architectural Component (“AR”) or Structural one (“ST”).

Field 7: Country (2 Characters)—Optional

The field is adopted to show where the component is made from. This field is filled based on the International style of the country abbreviations. Like “MY” for Malaysia, “UK” for United Kingdom and “IR” for Iran

Field 8: Product Number (2-10 Characters)—Optional

The field is adopted for the users' reference in order to make possible for them to flash back and find other required information about the component from any sources.

Field 9: User Define (3-10 Characters)—Optional

The field is adopted for the users' convenience to indicate whatever, they want as a reference for themselves.

For instance, the FIG. 5 is showing the generation of a coding syntax for an Aluminium Sliding Windows by Wintech Company in Malaysia with product no. of W110 for architectural practice in Section 0i3i4 in the plan. At first, the user should select the Component Listed Attributes and write the specification in the Other Attributes section; then click the generate button for generating the coding syntax “wn-al-wintech_{—}0i3i4-sl-ar-my-w110”, automatically. Also, the user can assign a description for the coding syntax within the gadget. Layer setting is also provided for controlling the duplicating the coding syntaxes using additional suffix to the end of the coding syntaxes. Layer archive is provided also for listing all the generated coding syntaxes in a preview window. Eventually coding syntaxes can exported in a Text file format for using in the CAD software.

Referring now to FIG. 6, there is shown a table that shows the coding syntaxes of the prefabricated construction components of a 3D model are assigned. The 3D Model is sliced in order to show how the component's code shaped based on the information given to the user and what their corresponded coding syntaxes for 3D objects are. However, some pre-required task should be done before setting the coding syntaxes. Some task like: defining column axis or making the decision on the position of the objects. Then, the coding rules should be set for initiating the modelling process. In an industrialised building system (IBS) project, the component names may become as many as the 3D objects are. The numbers of them are depended on the strategy that the user follows for him/her. Some user may want to make deference between each component or some others may suffice to the category of the components. Also, user should consider that the ‘n’ type of component's codes is required to have at least ‘n’ type of 3D objects. The table in FIG. 6 is showing the defined coding syntax like the first row “wn-al-wintech_{—}1i3i4-sl-ar-my-w110”, which means a window (wn) made by aluminium (al) by the Wintech Factory (wintech) in level) axis i3i4 (0i3i4), the single slider (sl), by architect (ar), in Malaysia (my) with reference number W110 (w110). This code is exactly refers to the single 3D object in the 3D model. At the end, for example, if the final model is consisted of 69 objects and consequently, 69 component codes are generated as well. That is easily showed how many factories support the fabricating process and provide this opportunity for other stakeholders to access to other information that many dismissed during 3D modelling.

Referring to FIG. 7, a computer screenshot shows an advanced technical searching system for distribution of the product information of the prefabricated construction components. The searching system provides index search dialogue box for instant query access. The system prioritises alternative selection based on searching criteria.

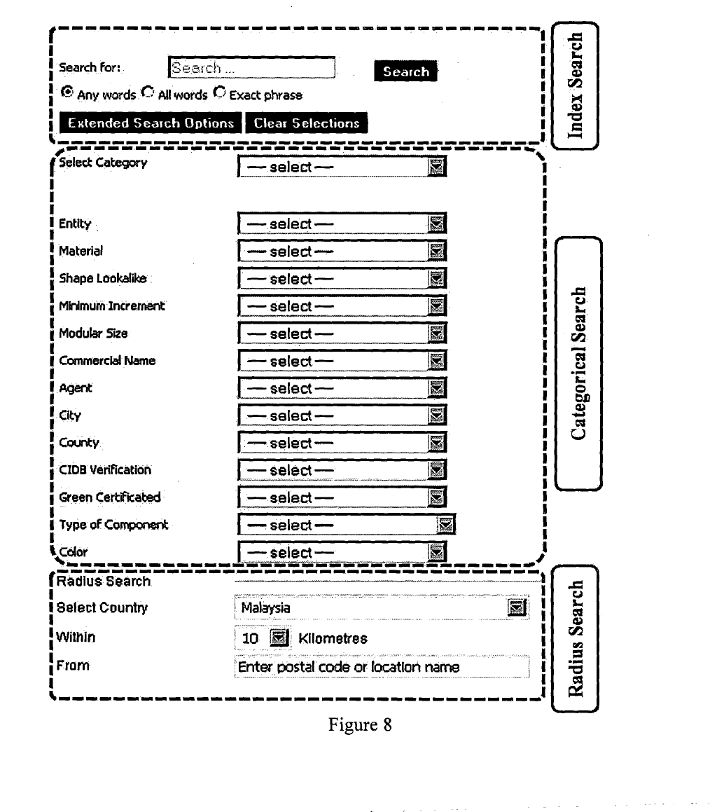

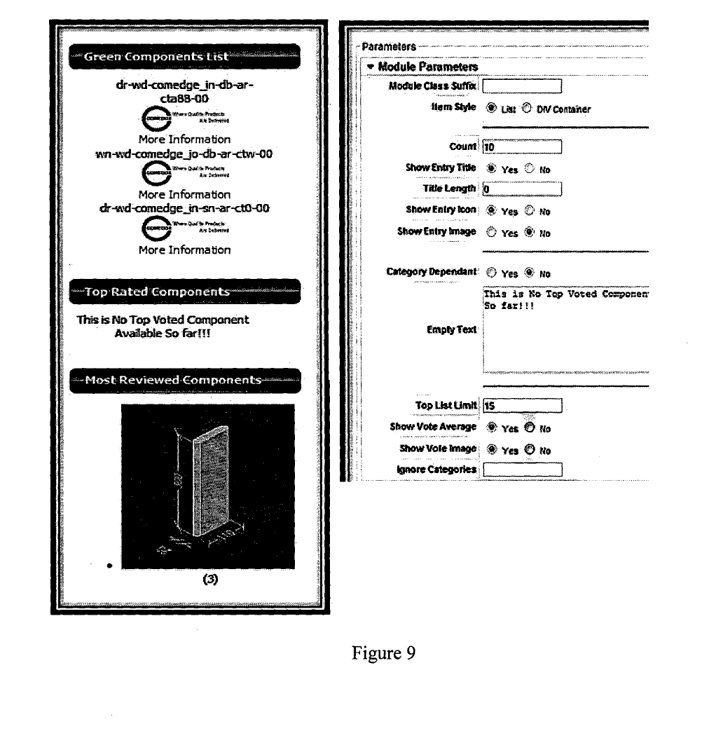

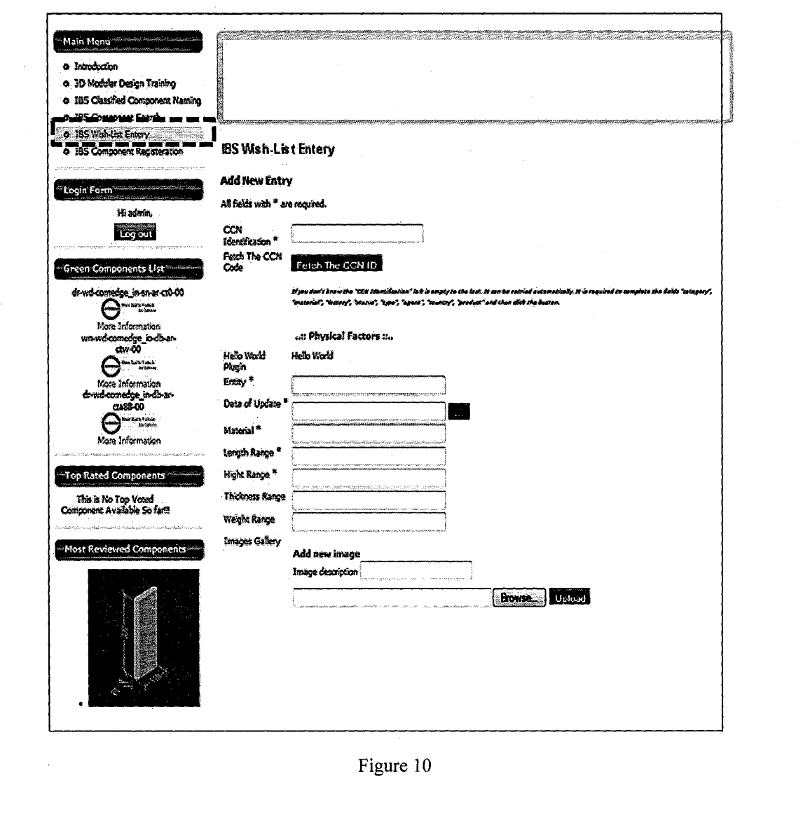

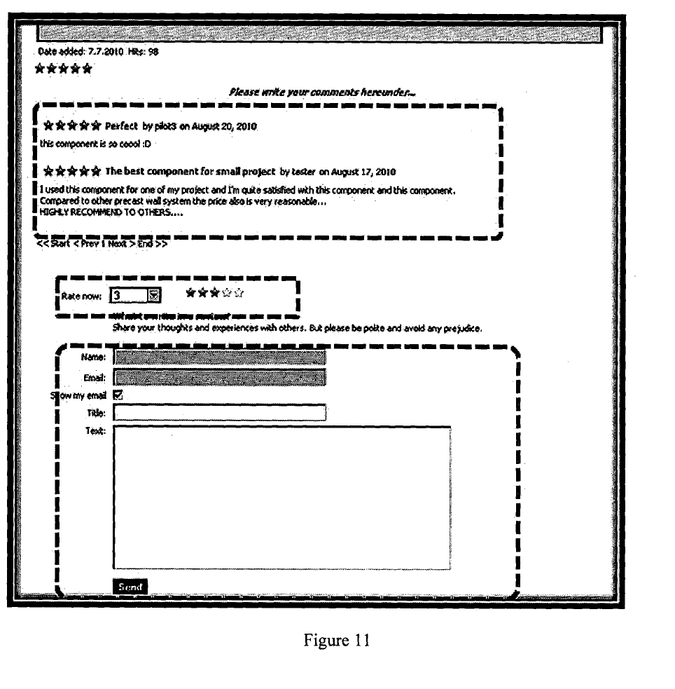

Referring to FIG. 8, a computer screenshot shows the favor identification module for identifying the most viewed and commented products and highlighting them as the most popular and favourable components in comparison to the others in the system. Referring to FIG. 9, a computer screenshot shows the reference module of the system for recording the architects' desired construction components for reference of the manufacturers in the system. Referring to FIG. 10, a computer screenshot shows the recommendation module for recording the architects' recommendation and rating about the stored components after the architects obtained the product information for each construction component. Referring to FIG. 11, a computer screenshot shows the available of contact information for ordering and enquiring of the selected components by the architects.

Although this disclosure has described and illustrated certain preferred embodiments of the invention, it is to be understood that the invention is not restricted to those particular embodiments. Rather, the invention includes all embodiments which are functional or mechanical equivalence of the specific embodiments and features that have been described and illustrated.

1-22. (canceled)

23. A method for providing and managing information of prefabricated construction components between manufacturers and architects for architectural modular design processes, comprising the steps of:
aggregating the manufacturers' product information relating to various prefabricated construction components;
generating a unique code to each prefabricated construction component automatically by a coding module upon synthesizing product information of the prefabricated construction components using coding syntaxes;
storing the product information in a database in the format of the unique codes; and
distributing the product information in the format of the unique codes on demand of architects for their architectural modular design processes;
wherein the unique code is an abbreviation relating to attributes of each of the prefabricated construction components that include any one or combination of mandatory information fields concerning element, material and brand of the prefabricated construction components.

24. The method according to claim 23, wherein the unique code includes a plurality of information fields relating to the prefabricated construction components.

25. The method according to claim 24, wherein the information fields are arranged systematically into mandatory and optional information fields.

26. The method according to claim 25, wherein the optional information fields are information relating to the sector, entity, agent, country, product number and user definition of the prefabricated construction components.

27. The method according to claim 23, wherein the product information of the prefabricated construction components to be aggregated from their manufacturers are parametrical information of the prefabricated construction components.

28. The method according to claim 23, wherein the step of distributing the product information of the prefabricated construction components is achieved by the architects using a searching system to search the database of the relevant production information for their modular design processes requirements.

29. The method according to claim 23, further comprising the step of identifying the most viewed and commented products and highlighting them as the most popular and favorable components in comparison to the others.

30. The method according to claim 23, further comprising the step of recording the architects' desired construction components for reference of the manufacturers.

31. The method according to claim 23, further comprising the step of recording the architects' recommendation about the stored components after the architects obtained the product information for each construction component from the database.

32. A system for providing and managing information of prefabricated construction components through a server and an interface between manufacturer and architect for architectural modular design processes, comprising:
an information aggregation module adapted to aggregate the manufacturers' product information relating to various prefabricated construction components;
a coding module adapted to generate a unique code to each prefabricated construction component automatically upon synthesizing the prefabricated construction components information using coding syntaxes;
a database adapted to store the product information in the format of the unique codes; and
an information distribution module adapted to distribute the product information in the format of the unique codes on demand of architects for their architectural modular design processes;
wherein the unique code is an abbreviation relating to attributes of each of the prefabricated construction components that include any one or combination of mandatory information fields concerning element, material and brand of the prefabricated construction components.

33. The system according to claim 32, wherein the unique code includes a plurality of information fields relating to the prefabricated construction components.

34. The system according to claim 33, wherein the information fields are arranged systematically in two mandatory and optional information fields.

35. The system according to claim 34, wherein the optional information fields are information relating to the sector, entity, agent, country, product number and user definition of the prefabricated construction components.

36. The system according to claim 32, wherein the product information of the construction components to be aggregated from their manufacturers are parametrical information of the construction components.

37. The system according to claim 32, wherein the information distribution module adapted to distribute the product information of the prefabricated construction components that is achieved by the architects using a searching system to search the database of the relevant production information for their modular design processes requirements.

38. The system according to claim 32, further comprising a favor identification module for identifying the most viewed and commented on products and highlighting them as the most popular and favorable components in comparison to any other products.

39. The system according to claim 32, further comprising a reference module for recording the architects' desired construction components for reference of the manufacturers.

40. The system according to claim 32, further comprising a recommendation module for recording the architects' recommendation about the stored component after the architects obtained the product information for each construction component from the database.
